(19) United States
(12) Patent Application Publication
(10) Pub. No.: US 2024/0429797 A1
(43) Pub. Date: Dec. 26, 2024

(54) METHOD FOR MANUFACTURING ROTOR

(71) Applicant: TOYOTA BOSHOKU KABUSHIKI KAISHA, Aichi-ken (JP)

(72) Inventor: Takeshi NOMURA, Chiryu-shi (JP)

(73) Assignee: TOYOTA BOSHOKU KABUSHIKI KAISHA, Aichi-ken (JP)

(21) Appl. No.: 18/743,988

(22) Filed: Jun. 14, 2024

(30) Foreign Application Priority Data
Jun. 21, 2023 (JP) 2023-101587

(51) Int. Cl. H02K 15/12; H02K 1/276; H02K 1/28; H02K 15/03

(52) U.S. Cl. CPC H02K 15/12; H02K 1/276; H02K 1/28; H02K 15/03

(57) ABSTRACT

A method for manufacturing a rotor includes filling magnet housing holes, which accommodate magnets, with plastic that has been heated to a specified temperature to be molten, thereby heating a rotor core with heat of the plastic, arranging an end plate on one end face in the axial direction of the rotor core, thereby heating the end plate with heat of the heated rotor core, and welding the end plate to the rotor core. The welding the end plate includes welding the end plate to the rotor core in a state in which, during decrease of temperatures of the rotor core and the end plate, the temperatures of the rotor core and the end plate are lower than the specified temperature and within an operational temperature range for use of the rotor.

### CROSS-REFERENCE TO RELATED APPLICATIONS

This application is based upon and claims the benefit of priority from prior Japanese Patent Application No. 2023-101587, filed on Jun. 21, 2023, the entire contents of which are incorporated herein by reference.

### BACKGROUND

### 1. Field

The present disclosure relates to a method for manufacturing a rotor.

### 2. Description of Related Art

Conventionally, rotors for rotating electric machines are known to include a tubular rotor core with magnet housing holes, magnets accommodated in the magnet housing holes and end plates welded to the rotor core. The magnets are fixed to the rotor core with plastic filling the magnet housing holes. The end plates are welded to the opposite ends in the axial direction of the rotor core to restrict projecting of the magnets from the magnet housing holes.

During the use of the rotating electric machine, the temperature of the entire rotor increases. Consequently, if the coefficient of linear expansion of the rotor core and that of the end plate are different from each other, the amount of deformation of the rotor core and that of the end plate during thermal expansion differ from each other. This difference generates internal stress at the welded portions between the rotor core and the end plates, potentially reducing the strength of the welded portions.

Japanese Laid-Open Patent Publication No. 2021-118567 discloses a method for manufacturing a rotor that involves cooling the rotor core to reduce the temperature difference between the opposite end faces of the rotor core when welding the end plates to the opposite ends in the axial direction of the rotor core. In the method of the above-described publication, after filling the magnet housing holes with thermosetting plastic, the rotor core is heated to a temperature equal to or above the curing temperature of the plastic. Subsequently, the rotor core is cooled by blowing air to ensure the temperatures of the opposite end faces of the rotor core fall within a temperature range during use of the rotor. In this manner, the end plates are welded to the opposite ends of the rotor core, which has been cooled to reduce the temperature difference between the end faces. This limits reduction in the strength of the welded portions of the rotor core and the end plates.

In the method of the above-described publication, after the magnet housing holes are filled with the plastic, the rotor core is heated to thermally cure the plastic. After the rotor core is cooled, the end plates are welded to the rotor core. This manufacturing process of the rotor requires considerable time, indicating room for improvement in enhancing the productivity of rotor manufacturing.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method for manufacturing a rotor is provided. The rotor includes a tubular rotor core including multiple magnet housing holes, magnets accommodated in the magnet housing holes, plastic that is a thermoplastic and fills the magnet housing holes to fix the magnets to the rotor core, and an end plate made of a material having a coefficient of linear expansion different from that of the rotor core. The end plate is welded to an end of the rotor core in an axial direction. The method for manufacturing the rotor includes filling the magnet housing holes, which accommodate the magnets, with the plastic that has been heated to a specified temperature to be molten, thereby heating the rotor core with heat of the plastic, arranging the end plate on one end face in the axial direction of the rotor core filled with the plastic, thereby heating the end plate with heat of the heated rotor core, and welding the end plate to the rotor core. The welding the end plate includes welding the end plate to the rotor core in a state in which, during decrease of temperatures of the rotor core and the end plate, the temperatures of the rotor core and the end plate are lower than the specified temperature and within an operational temperature range of the rotor.

In another general aspect, a method for manufacturing a rotor is provided. The rotor includes a tubular rotor core including multiple magnet housing holes, magnets accommodated in the magnet housing holes, plastic that is a thermoplastic and fills the magnet housing holes to fix the magnets to the rotor core, and an end plate made of a material having a coefficient of linear expansion different from that of the rotor core. The end plate is welded to an end of the rotor core in an axial direction. The method for manufacturing the rotor includes filling the magnet housing holes, which accommodate the magnets, with the plastic that has been heated to a specified temperature to be molten, thereby heating the rotor core with heat of the plastic, arranging the preheated end plate on one end face in the axial direction of the rotor core filled with the plastic, and welding the end plate to the rotor core. The welding the end plate includes welding the end plate to the rotor core in a state in which, during decrease of temperatures of the rotor core and the end plate, the temperatures of the rotor core and the end plate are lower than the specified temperature and within an operational temperature range of the rotor.

Other features and aspects will be apparent from the following detailed description, the drawings, and the claims.

### BRIEF DESCRIPTION OF THE DRAWINGS

FIG. 1 is a cross-sectional view of a rotor that is manufactured through a rotor manufacturing method according to one embodiment.

FIG. 2 is a plan view of the rotor core shown in FIG. 1.

FIG. 3 is an enlarged plan view of the rotor shown in FIG. 1.

FIG. 4 is a cross-sectional view a molding device for manufacturing the rotor shown in FIG. 1.

FIG. 5 is a cross-sectional view illustrating a state in which magnet housing holes of the rotor core shown in FIG. 1 are filled with plastic.

FIG. 6 is a cross-sectional view illustrating a state in which a first end plate and a second end plate are arranged on the rotor core shown in FIG. 1.

FIG. 7 is a cross-sectional view illustrating a state in which the first end plate and the second end plate are welded to the rotor core shown in FIG. 1.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

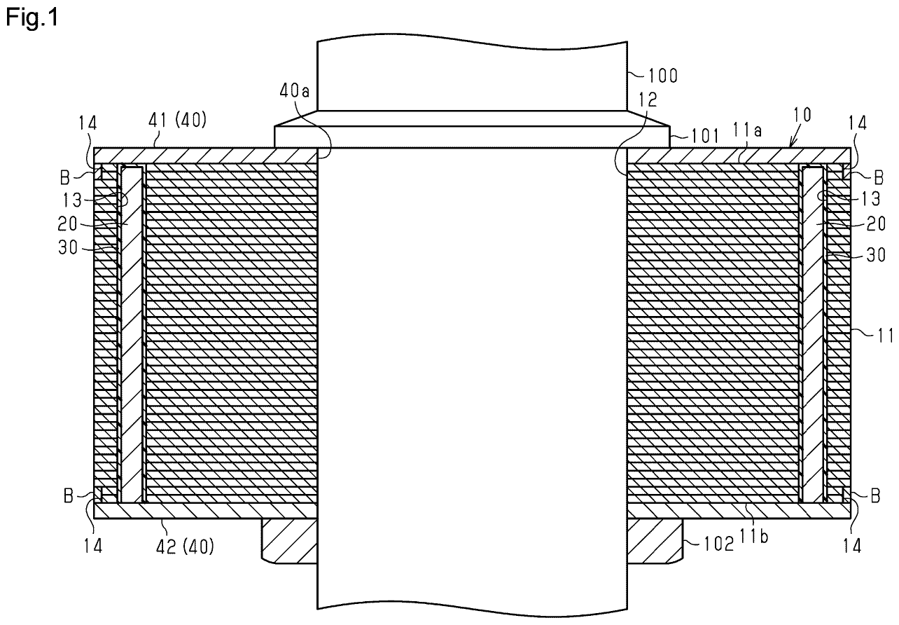

A method for manufacturing a rotor according to one embodiment will now be described with reference to FIGS. 1 to 7.

### Rotor 10

As shown in FIG. 1, a rotor 10 includes a rotor core 11, magnets 20, plastic 30, and two end plates 40. The rotor 10 is, for example, a rotor used for a magnet-embedded motor.

### Rotor Core 11

The rotor core 11 is substantially cylindrical. The rotor core 11 is formed, for example, by stacking iron core pieces that are punched out from a magnetic steel sheet.

In the following description, the axial direction of the rotor core 11 will simply be referred to as an axial direction. The radial direction of the rotor core 11 will simply be referred to as a radial direction. The circumferential direction of the rotor core 11 will simply be referred to as a circumferential direction.

The rotor core 11 includes a first end face 11a and a second end face 11b, which are located on opposite sides in the axial direction.

The rotor core 11 includes a center hole 12, into which a shaft 100 is inserted, and magnet housing holes 13, in which the magnets 20 are accommodated. The magnet housing holes 13 are formed at intervals in the circumferential direction.

The center hole 12 and the magnet housing holes 13 extend through the rotor core 11 in the axial direction. That is, the center hole 12 and the magnet housing holes 13 both open in the first end face 11a and the second end face 11b.

The rotor core 11 with the end plates 40 welded to the opposite ends in the axial direction is fixed to the shaft 100 in a state of being sandwiched in the axial direction by a flange 101 formed on the shaft 100 and a nut 102 threaded onto the shaft 100.

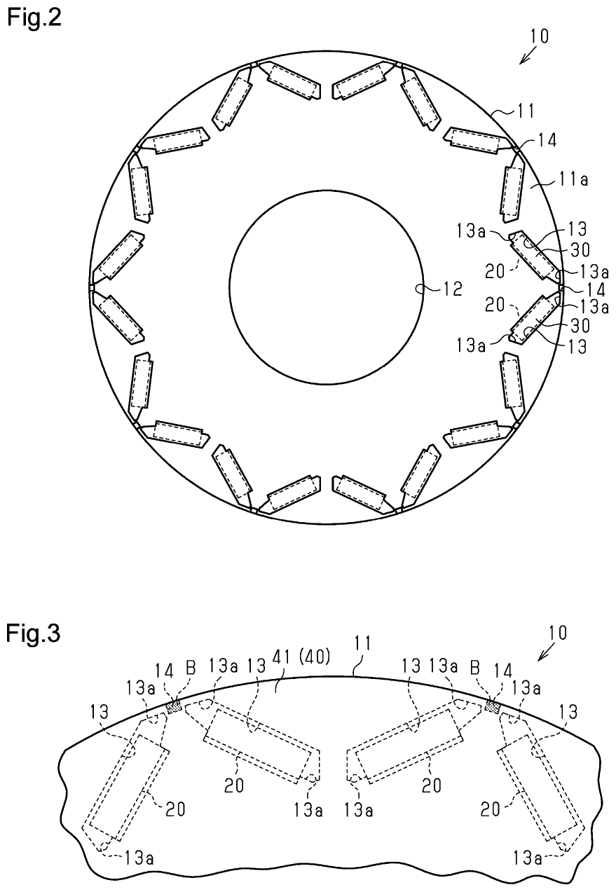

As shown in FIG. 2, each magnet housing hole 13 has a substantially rectangular cross-sectional shape orthogonal to the axial direction. The rectangular cross-sectional shape includes long sides and short sides. The cross-sectional shape of each magnet housing hole 13 is constant over the entire length in the axial direction.

The rotor core 11 includes a total of ten pairs of adjacent magnet housing holes 13 arranged in the circumferential direction. The two magnet housing holes 13 in each pair are V-shaped such that the distance in the circumferential direction decreases toward the radially outer ends. Each magnet housing hole 13 includes filling portions 13a, which are filled with the plastic 30 at the opposite ends in the long-side direction.

As shown in FIG. 1, the rotor core 11 includes welding grooves 14 on the outer circumferential surface at the opposite ends in the axial direction. The welding grooves 14 extend, for example, partially in the axial direction on the outer circumferential surface of the rotor core 11.

As shown in FIG. 3, the welding grooves 14 are arranged at intervals in the circumferential direction of the rotor core 11. The welding grooves 14 are each formed in an outer circumferential portion of the rotor core 11 between the filling portions 13a, which are located on the radially outer sides of two of the magnet housing holes 13.

### Magnets 20

Each magnet 20 is accommodated in one of the magnet housing holes 13. The magnets 20 are fixed to the rotor core 11 with the plastic 30 filling the magnet housing holes 13.

The magnets 20 are, for example, permanent magnets.

As shown in FIG. 1, each magnet 20 has a shape elongated in the axial direction. The length of each magnet 20 in the axial direction is shorter than the length of the rotor core 11 in the axial direction.

One end face in the axial direction of each magnet 20 is located, for example, inward from the first end face 11a in the axial direction. The other end face of each magnet 20 on the opposite side in the axial direction from the one end face is, for example, flush with the second end face 11b.

### Plastic 30

The plastic 30 fills, for example, the entire circumference of the each magnet 20 between the inner surface of the magnet housing hole 13 and the outer surface of the magnet 20.

The plastic 30 covers one end face in the axial direction of the magnet 20 and is flush with the first end face 11a of the rotor core 11.

The plastic 30 is, for example, a thermoplastic such as a liquid-crystal polymer.

### End Plates 40

The end plates 40 are welded to the opposite ends in the axial direction of the rotor core 11 via beads B formed in the welding grooves 14.

The end plates 40 are shaped as circular plates that correspond to the shapes of the opposite end faces in the axial direction of the rotor core 11. The end plates 40 each include a through-hole 40a, which is connected to the center hole 12.

The end plates 40 are made of a material having a different coefficient of linear expansion from that of the rotor core 11. The coefficient of linear expansion of the end plates 40 is greater than, for example, the coefficient of linear expansion of the rotor core 11. The end plates 40 are made of, for example, a metal material such as stainless steel.

The term “end plate 40” collectively refers to a first end plate 41 and a second end plate 42. The first end plate 41 and the second end plate 42 have identical shapes.

The first end plate 41 covers the first end face 11a of the rotor core 11. The first end plate 41 thus covers the openings of all the magnet housing holes 13 that open in the first end face 11a. The second end plate 42 covers the second end face 11b of the rotor core 11. The second end plate 42 thus covers the openings of all the magnet housing holes 13 that open in the second end face 11b.

### Molding Device 50

A molding device 50 that fills the magnet housing holes 13 with the plastic 30 will now be described.

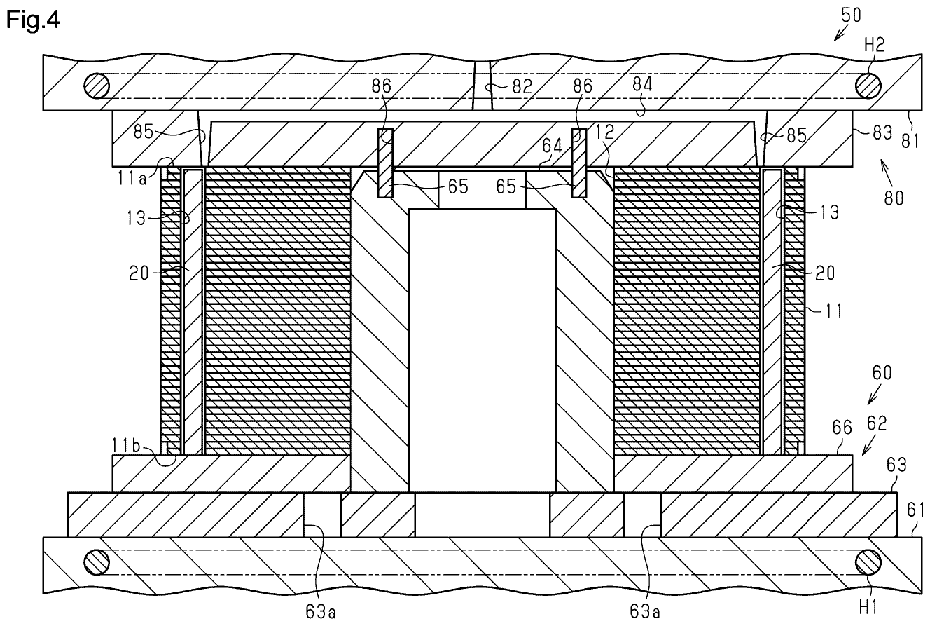

As shown in FIG. 4, the molding device 50 includes a first die 60 and a second die 80.

### First Die 60

The first die 60 includes a first die body 61 and a pallet 62.

The first die body 61 includes a supporting surface, which supports the lower surface of the pallet 62.

The first die body 61 incorporates, for example, a first heater H1, which generates heat when energized.

The pallet 62 is conveyed to a position between the first die body 61 and the second die 80, while supporting the rotor core 11.

The pallet 62 includes a base plate 63, a post 64, which protrudes from a central portion of the base plate 63, and a spacer 66, which is arranged on the upper surface of the base plate 63. The post 64 extends through the spacer 66.

The base plate 63 and the spacer 66 are each shaped as a flat plate. The post 64 is cylindrical.

The base plate 63 includes through-holes 63a on the radially outer side of the post 64. The through-holes 63a are spaced apart from each other in the circumferential direction. The through-holes 63a are covered with the spacer 66.

The post 64 is inserted into the center hole 12 of the rotor core 11. Engaging pins 65 are disposed at the tip of the post 64. The engaging pins 65 are spaced apart from each other in the circumferential direction.

The spacer 66 supports the second end face 11b of the rotor core 11, in which the post 64 is inserted.

### Second Die 80

The second die 80 includes a second die body 81 and a gate plate 83. The second die body 81 and the gate plate 83 are, for example, formed separately.

The second die body 81 is, for example, a movable die that is capable of approaching and moving away from the first die body 61. The second die body 81 includes a sprue 82, through which the plastic 30 injected from an injection device (not shown) flows.

The second die body 81 incorporates, for example, a second heater H2, which generates heat when energized.

The gate plate 83 is disposed between the second die body 81 and the rotor core 11. The gate plate 83 includes runners 84, which are connected to the sprue 82, and multiple gates 85, which extend from the runners 84.

The runners 84 open in the upper surface of the gate plate 83. The runners 84 extend radially from a central portion of the gate plate 83 in the radial direction. The gates 85 open in the lower surface of the gate plate 83. The gates 85 connect the ends of the runners 84 to the magnet housing holes 13.

The gate plate 83 includes engaging holes 86 in the lower surface. The engaging pins 65 of the post 64 are engaged with the engaging holes 86. Engagement of the engaging pins 65 with the engaging holes 86 determines the position of the gate plate 83 with respect to the pallet 62.

### Method for Manufacturing Rotor 10

The method for manufacturing the rotor 10 includes a magnet accommodating step, a die clamping step, a filling step, a removing step, an arranging step, and a welding step. The magnet accommodating step, the die clamping step, the filling step, the removing step, the arranging step, and the welding step are performed in that order.

### Magnet Accommodating Step

As shown in FIG. 4, in the magnet accommodating step, the magnets 20 are accommodated in the magnet housing holes 13 of the rotor core 11, which is supported by the pallet 62. At this time, the lower surface of each magnet 20 is in contact with the upper surface of the spacer 66.

### Die Clamping Step

In the die clamping step, first, the pallet 62, which supports the rotor core 11, is placed on the supporting surface of the first die body 61. Then, the gate plate 83 is placed on the first end face 11a of the rotor core 11. Thus, the first end face 11a of the rotor core 11 is entirely covered with the gate plate 83. Thereafter, the first die 60 and the second die 80 are clamped to sandwich the rotor core 11 in the axial direction.

In the die clamping step, the first die body 61 is heated by energizing the first heater H1, and the second die body 81 is heated by energizing the second heater H2. For example, the heating temperature of the first die body 61 and the heating temperature of the second die body 81 are set to be the same temperature. The first die body 61 and the second die body 81 are heated to temperatures lower than the temperature of the plastic 30, which is heated to a specified temperature to be melted in the filling step, which will be discussed below. Specifically, the first die body 61 and the second die body 81 are heated to temperatures lower than an operational temperature range, in which the rotor 10 is used. The first die body 61 and the second die body 81 are heated to, for example, approximately 40° C. The operational temperature range is a temperature range in which the temperature of the entire rotor 10 increases due to, for example, heat generation of the magnets 20 during use of the rotor 10. The operational temperature range is, for example, 60° C. to 100° C.

When the first die body 61 and the second die body 81 are heated, the second end face 11b of the rotor core 11 is heated through the pallet 62, and the first end face 11a of the rotor core 11 is heated through the gate plate 83. The temperature of the rotor core 11 immediately before heating is performed by the first die body 61 and the second die body 81 is, for example, a normal temperature and lower than the operational temperature range. In this specification, “normal temperature” refers to 20° C.±15° C.

### Filling Step

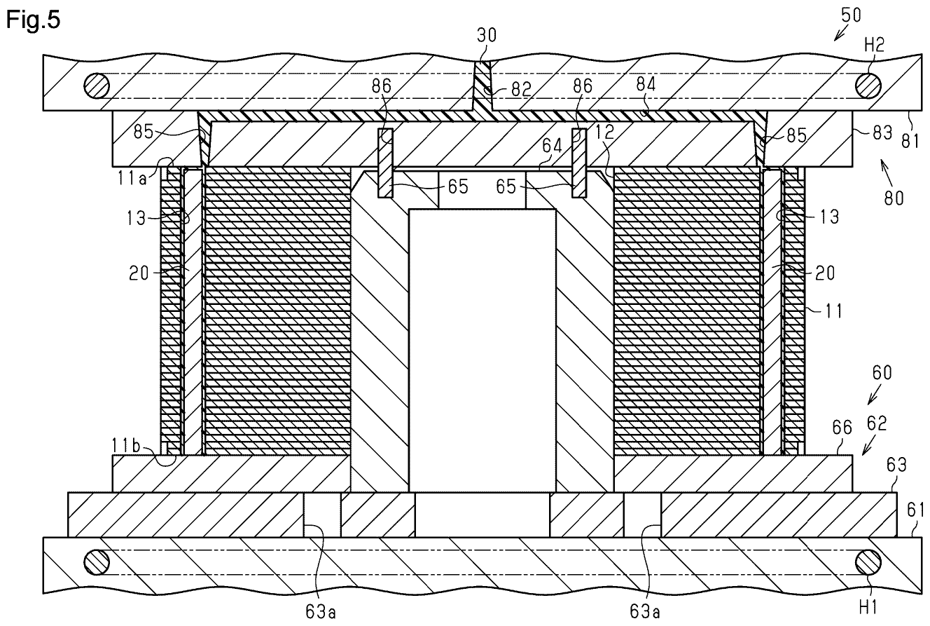

In the filling step, in a state in which the first die body 61 and the second die body 81 are heated to temperatures lower than the operational temperature range, the injection device (not shown) fills the magnet housing holes 13 with the plastic 30 through the second die 80 as shown in FIG. 5. In the filling step, the plastic 30 that has been heated to a specified temperature to be melted fills the magnet housing holes 13 through the gates 85. The plastic 30 is, for example, heated to approximately 350° C. to be melted and injected from the injection device.

When the magnet housing holes 13 are filled with the plastic 30, the heat of the plastic 30 heats the rotor core 11. The rotor core 11 is thus heated by the heat of the plastic 30 and the heat of the first die 60 and the second die 80.

The temperature of the plastic 30 decreases during a period from when the plastic is injected from the injection device to when the plastic reaches the magnet housing holes 13 via the second die 80. Although the rotor core 11 is also heated by the heat of the first die 60 and the second die 80, the rotor core 11 is heated to a temperature within or beyond the operational temperature range only by the heat of the plastic 30.

### Removing Step

In the removing step, the spacer 66 is pressed from below by a lifting member (not shown) inserted into the through-holes 63a of the base plate 63. Thus, the rotor core 11 is moved together with the spacer 66 in a direction in which the rotor core 11 is removed from the post 64, so that the rotor core 11 is removed from the post 64.

### Arranging Step

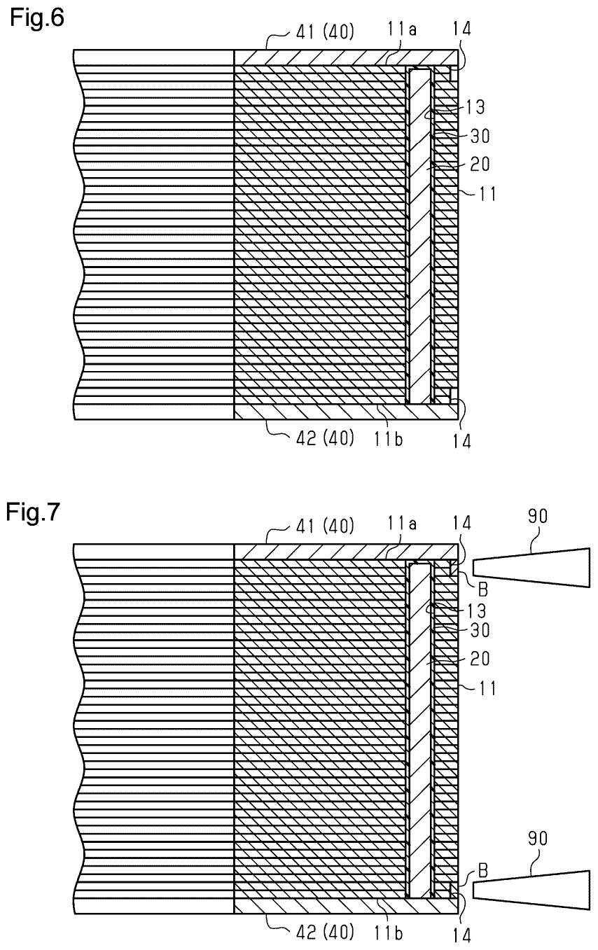

As shown in FIG. 6, in the arranging step, the first end plate 41 and the second end plate 42 are respectively arranged on the first end face 11a and the second end face 11b of the rotor core 11, which is filled with the plastic 30. In the arranging step, for example, the rotor core 11 is placed on the second end plate 42, and the first end plate 41 is placed on the rotor core 11. The end plates 40 are arranged on the first end face 11a and the second end face 11b of the rotor core 11, so that the end plates 40 are heated by the heat of the rotor core 11, which has been heated in the filling step. The temperature immediately before the end plates 40 are arranged on the first end face 11a and the second end face 11b of the rotor core 11 is lower than the operational temperature range and is, for example, a normal temperature.

The end plates 40 are arranged on the first end face 11a and the second end face 11b of the rotor core 11, for example, when the temperature of the plastic 30 filling the magnet housing holes 13 is lower than the melting point and higher than the glass transition point, and when the plastic 30 is in a soft rubber-like state. Thus, the end plates 40 are arranged on the rotor core 11 while maintaining the shapes of the plastic 30 inside the magnet housing holes 13.

### Welding Step

As shown in FIG. 7, in the welding step, two welding torches 90 weld the first end plate 41 and the second end plate 42 to the rotor core 11. The welding torches 90 are, for example, torches for laser beam welding.

In the welding step, during decrease of the temperatures of the rotor core 11 and the end plates 40, the end plates 40 are welded to the rotor core 11 when the temperatures of the rotor core 11 and the end plates 40 are within the operational temperature range.

In the welding step, the second end plate 42 is welded to the rotor core 11 after the first end plate 41 is welded to the rotor core 11. The first end plate 41 is welded to the rotor core 11 when the temperatures of the rotor core 11 and the first end plate 41 are within the operational temperature range. The second end plate 42 is welded to the rotor core 11 when the temperatures of the rotor core 11 and the second end plate 42 are within the operational temperature range.

In the welding step, each end plate 40 is successively welded in the circumferential direction to multiple portions that are located at intervals in the circumferential direction of the rotor core 11 in a state in which the temperatures of the rotor core 11 and the end plates 40 are within the operational temperature range. At this time, the outer circumferential portion of the end plate 40 is welded to parts of the outer circumferential portion of the rotor core 11 between the filling portions 13a, which are located radially outward of the pairs of the magnet housing holes 13.

Operation and advantages of the present embodiment will now be described.

(1) In the filling step, the magnet housing holes 13, which accommodate the magnets 20, are filled with the 30, which have been heated to the specified temperature to be molten, thereby heating the rotor core 11 with heat of the plastic 30. In the arranging step, the end plates 40 are arranged on the first end face 11a and the second end face 11b of the rotor core 11, filled with the plastic 30, so that the end plates 40 are heated by the heat of the rotor core 11, which has been heated. In the welding step, during decrease of the temperatures of the rotor core 11 and the end plates 40, the end plates 40 are welded to the rotor core 11 when the temperatures of the rotor core 11 and the end plates 40 are within the operational temperature range.

With the above-described method, the end plates 40 are welded to the rotor core 11 when the temperatures of the rotor core 11 and the end plates 40 are within the operational temperature range. This limits reduction in the strength of the welded portions of the rotor core 11 and the end plates 40.

When the molten plastic 30, which is thermoplastic, fills the magnet housing holes 13, the rotor core 11 is heated by the heat of the plastic 30. Also, the end plates 40 are arranged on the first end face 11a and the second end face 11b of the heated rotor core 11, so as to be heated by the heat of the rotor core 11. Then, during decrease of the temperatures of the rotor core 11 and the end plates 40, the end plates 40 are welded to the rotor core 11 while the temperatures of the rotor core 11 and the end plates 40 are within the operational temperature range. Accordingly, the heat of the molten plastic 30 is used to cause the temperatures of the rotor core 11 and the end plates 40 to be within the operational temperature range. This process allows for the simultaneous filling of the magnet housing holes 13 with the plastic 30 and the heating of the rotor core 11. Consequently, the productivity of the rotor 10 is improved.

For example, when the plastic 30 is a thermosetting plastic, the entire rotor core 11 is heated to a temperature higher than or equal to the thermosetting temperature of the plastic 30. Consequently, the higher the thermosetting temperature compared to the operational temperature range, the longer it takes for the temperature of the rotor core 11 to drop to a temperature within the operational temperature range. Additionally, a cooling process for the rotor core 11 becomes necessary.

In this regard, with the above-described method, the rotor core 11 is heated by the heat of the plastic 30 filling the magnet housing holes 13. Since the heating source that heats the rotor core 11 is a part of the rotor core 11, the heat of the plastic 30 is conducted to the entire rotor core 11 immediately after the magnet housing holes 13 are filled with the plastic 30. The rotor core 11 is thus unlikely to be heated excessively. As a result, the difference between the temperature of the rotor core 11 increased by the heat of the plastic 30 and temperatures within the operational temperature range is likely to be reduced. This shortens the time required for the temperature of the rotor core 11 to drop to a temperature in the operational temperature range. Also, a step for cooling the rotor core 11 is unnecessary.

(2) In the filling step, the magnet housing holes 13 are filled with the plastic 30 in a state in which the rotor core 11 is sandwiched in the axial direction by the first die 60 and the second die 80, and the first die 60 and the second die 80 are heated to temperatures lower than the operational temperature range.

With the above-described method, when the magnet housing holes 13 are filled with the plastic 30, the rotor core 11 is sandwiched between the first die 60 and the second die 80. At this time, the rotor core 11 is heated by the first die 60 and the second die 80. The first die 60 and the second die 80 are heated to temperatures lower than the operational temperature range. This allows the rotor core 11 to be entirely heated including sections separated from the magnet housing holes 13, which are filled with the plastic 30, while preventing the temperature of the rotor core 11 from exceeding the operational temperature range. This allows the temperature of the rotor core 11 to be within the operational temperature range. Also, since the first die 60 and the second die 80 are heated, the viscosity of the plastic 30 is prevented from being reduced inside the second die 80 and the magnet housing holes 13. This allows the magnet housing holes 13 to be filled with the plastic 30 in a favorable manner. Accordingly, the productivity of the rotor 10 is further improved.

(3) In the welding step, the end plate 40 is welded to parts of the outer circumferential portion of the rotor core 11 between the filling portions 13a of the magnet housing holes 13 in the respective pairs.

Since the filling portions 13a are filled with the plastic 30, parts of the outer circumferential portion of the rotor core 11 in the vicinity of the filling portions 13a are heated by the heat of the plastic 30 before other portions. With the above-described method, in the welding step, the end plate 40 is welded to parts of the outer circumferential portion of the rotor core 11 between the filling portions 13a of the magnet housing holes 13 in the respective pairs. This allows the welding step to be performed after the portions to be welded of the rotor core 11 and the end plate 40 are heated at an early stage.

(4) In the filling step, the magnet housing holes 13 are filled with the plastic 30 from the side corresponding to the first end face 11a of the rotor core 11. In the arranging step, the first end plate 41 and the second end plate 42 are respectively arranged on the first end face 11a and the second end face 11b of the rotor core 11. In the welding step, the first end plate 41 is welded to the rotor core 11 when the temperatures of the rotor core 11 and the first end plate 41 are within the operational temperature range. Thereafter, the second end plate 42 is welded when the temperatures of the rotor core 11 and the second end plate 42 are within the operational temperature range.

With the above-described method, the first end plate 41 is disposed on the first end face 11a of the rotor core 11, which through which the plastic 30 is injected. The second end plate 42 is arranged on the second end face 11b of the rotor core 11, which is on the side opposite to the side through which the plastic 30 is injected. Since the magnet housing holes 13 are filled with the plastic 30 from the side corresponding to the first end face 11a, the temperature of the rotor core 11 tends to be higher on the side corresponding to the first end face 11a than on the side corresponding to the second end face 11b. Thus, the heat of the rotor core 11 readily causes the temperature of the first end plate 41 to reach a temperature within the operational temperature range before the second end plate 42. With the above-described method, in the welding step, the first end plate 41 is welded to the rotor core 11 before the second end plate 42. Thus, even before the temperature of the second end plate 42 reaches the operational temperature range, the first end plate 41 can be welded to the rotor core 11 if the temperature of the first end plate 41 has reached the operational temperature range. The second end plate 42 can be welded to the rotor core 11 if the temperature of the second end plate 42 has reached the operational temperature range while welding the first end plate 41 to the rotor core 11. Accordingly, it is possible to start the welding process for attaching the first end plate 41 and the second end plate 42 to the rotor core 11 before both the temperatures of the first end plate 41 and the second end plate 42 reach the operational temperature range.

(5) In the welding step, each end plate 40 is successively welded to multiple portions that are located at intervals in the circumferential direction of the rotor core 11 in a state in which the temperatures of the rotor core 11 and the end plates 40 are within the operational temperature range.

The above-described method limits reduction in the strength of the welded portions of the rotor core 11 and the end plates 40.

### Modifications

The above-described embodiment may be modified as follows. The above-described embodiment and the following modifications can be combined as long as the combined modifications remain technically consistent with each other.

In the welding step, each end plate 40 and parts of the rotor core 11 that are spaced apart from each other in the circumferential direction may be welded at the same time by using multiple welding torches 90.

In the arranging step, the first end plate 41 and the second end plate 42 may be simultaneously arranged on the rotor core 11. Alternatively, one of the first end plate 41 and the second end plate 42 may be arranged in the rotor core 11 prior to the other.

In the welding step, the end plate 40 that is arranged at one of the first end face 11a and the second end face 11b may be welded to the rotor core 11. In this case, the rotor 10 includes one of the first end plate 41 and the second end plate 42.

In the welding step, any part of the outer circumferential portion of the rotor core 11 may be welded to the outer circumferential portion of each end plate 40.

In the filling step, the magnet housing holes 13 may be filled with the plastic 30 in a state in which only one of the first die 60 and the second die 80 is heated to a temperature lower than the temperature in operational temperature range.

In the filling step, the first die 60 and the second die 80 do not necessarily need to be heated. In this case, the rotor core 11 is heated solely by the heat of the plastic 30 filling the magnet housing holes 13. Therefore, it is not necessary to heat the rotor core 11 separately by means other than the heat from the plastic 30.

In the arranging step, preheated end plates 40 may be arranged on the first end face 11a and the second end face 11b of the rotor core 11. At this time, the end plates 40 may be preheated to temperatures within the operational temperature range, or may be preheated to temperatures higher or lower than the operational temperature range. With this method, when the molten plastic 30, which is a thermoplastic, fills the magnet housing holes 13, the rotor core 11 is heated by the heat of the plastic 30. The end plates 40 are arranged on the first end face 11a and the second end face 11b of the rotor core 11 in a preheated state. Then, during decrease of the temperatures of the rotor core 11 and the end plates 40, the end plates 40 are welded to the rotor core 11 while the temperatures of the rotor core 11 and the end plates 40 are within the operational temperature range. Accordingly, the heat of the molten plastic 30 and the heat of the preheated end plates 40 are used to cause the temperatures of the rotor core 11 and the end plates 40 to be within the operational temperature range. This process allows for the simultaneous filling of the magnet housing holes 13 with the plastic 30 and the heating of the rotor core 11. Also, the welding step can be started at an early stage immediately after the arranging step. Consequently, the productivity of the rotor 10 is improved.

The end plates 40 may be made of a material having a smaller coefficient of linear expansion than that of the rotor core 11.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A method for manufacturing a rotor, the rotor including a tubular rotor core including multiple magnet housing holes, magnets accommodated in the magnet housing holes, plastic that is a thermoplastic and fills the magnet housing holes to fix the magnets to the rotor core, and an end plate made of a material having a coefficient of linear expansion different from that of the rotor core, the end plate being welded to an end of the rotor core in an axial direction, the method for manufacturing the rotor comprising:
filling the magnet housing holes, which accommodate the magnets, with the plastic that has been heated to a specified temperature to be molten, thereby heating the rotor core with heat of the plastic;
arranging the end plate on one end face in the axial direction of the rotor core filled with the plastic, thereby heating the end plate with heat of the heated rotor core; and
welding the end plate to the rotor core,
wherein the welding the end plate includes welding the end plate to the rotor core in a state in which, during decrease of temperatures of the rotor core and the end plate, the temperatures of the rotor core and the end plate are lower than the specified temperature and within an operational temperature range of the rotor.

2. The method for manufacturing the rotor according to claim 1, wherein the filling the magnet housing holes with the plastic includes:
sandwiching, in the axial direction, the rotor core between a first die and a second die; and
filling the magnet housing holes with the plastic in a state in which at least one of the first die and the second die is heated to a temperature lower than the operational temperature range.

3. The method for manufacturing the rotor according to claim 1, wherein
two of the magnet housing holes that are adjacent to each other in a circumferential direction of the rotor core are formed such that a distance between the magnet housing holes in the circumferential direction decreases toward an outer end in a radial direction of the rotor core, the magnet housing holes each including a filling portion that is filled with the plastic at an end on an outer side in the radial direction, and
the welding the end plate includes welding the end plate to a part of an outer circumferential portion of the rotor core between the filling portions of the two magnet housing holes.

4. The method for manufacturing the rotor according to claim 1, wherein
the rotor includes:
a first end plate that is the end plate welded to one of opposite end portions in the axial direction of the rotor core; and
a second end plate that is the end plate welded to the other end,
the filling the magnet housing holes with the plastic includes filling the magnet housing holes with the plastic from one side in the axial direction of the rotor core,
the arranging the end plate includes:
arranging the first end plate on an end face on the one side of the rotor core; and
arranging the second end plate on an end face of the rotor core on a side opposite to the one side, and
the welding the end plate includes:
welding the first end plate to the rotor core in a state in which the temperatures of the rotor core and the first end plate are within the operational temperature range; and
after welding the first end plate, welding the second end plate to the rotor core in a state in which the temperatures of the rotor core and the second end plate are within the operational temperature range.

5. The method for manufacturing the rotor according to claim 1, wherein the welding the end plate includes successively welding the end plate to multiple parts that are located at intervals in a circumferential direction of the rotor core in a state in which the temperatures of the rotor core and the end plate are within the operational temperature range.

6. A method for manufacturing a rotor, the rotor including a tubular rotor core including multiple magnet housing holes, magnets accommodated in the magnet housing holes, plastic that is a thermoplastic and fills the magnet housing holes to fix the magnets to the rotor core, and an end plate made of a material having a coefficient of linear expansion different from that of the rotor core, the end plate being welded to an end of the rotor core in an axial direction, the method for manufacturing the rotor comprising:
filling the magnet housing holes, which accommodate the magnets, with the plastic that has been heated to a specified temperature to be molten, thereby heating the rotor core with heat of the plastic;
arranging the preheated end plate on one end face in the axial direction of the rotor core filled with the plastic; and
welding the end plate to the rotor core,
wherein the welding the end plate includes welding the end plate to the rotor core in a state in which, during decrease of temperatures of the rotor core and the end plate, the temperatures of the rotor core and the end plate are lower than the specified temperature and within an operational temperature range of the rotor.

7. The method for manufacturing the rotor according to claim 6, wherein the filling the magnet housing holes with the plastic includes:
sandwiching, in the axial direction, the rotor core between a first die and a second die; and
filling the magnet housing holes with the plastic in a state in which at least one of the first die and the second die is heated to a temperature lower than the operational temperature range.

8. The method for manufacturing the rotor according to claim 6, wherein
two of the magnet housing holes that are adjacent to each other in a circumferential direction of the rotor core are formed such that a distance between the magnet housing holes in the circumferential direction decreases toward an outer end in a radial direction of the rotor core, the magnet housing holes each including a filling portion that is filled with the plastic at an end on an outer side in the radial direction, and
the welding the end plate includes welding the end plate to a part of an outer circumferential portion of the rotor core between the filling portions of the two magnet housing holes.

9. The method for manufacturing the rotor according to claim 6, wherein
the rotor includes:
a first end plate that is the end plate welded to one of opposite end portions in the axial direction of the rotor core; and
a second end plate that is the end plate welded to the other end,
the filling the magnet housing holes with the plastic includes filling the magnet housing holes with the plastic from one side in the axial direction of the rotor core,
the arranging the end plate includes:
arranging the first end plate on an end face on the one side of the rotor core; and
arranging the second end plate on an end face of the rotor core on a side opposite to the one side, and
the welding the end plate includes:
welding the first end plate to the rotor core in a state in which the temperatures of the rotor core and the first end plate are within the operational temperature range; and
after welding the first end plate, welding the second end plate to the rotor core in a state in which the temperatures of the rotor core and the second end plate are within the operational temperature range.

10. The method for manufacturing the rotor according to claim 6, wherein the welding the end plate includes successively welding the end plate to multiple portions that are located at intervals in a circumferential direction of the rotor core in a state in which the temperatures of the rotor core and the end plate are within the operational temperature range.
